(19) United States
(12) Patent Application Publication
(10) Pub. No.: US 2019/0012678 A1
(43) Pub. Date: Jan. 10, 2019

(54) E-COMMERCE PLATFORM AND PRODUCT CERTIFICATION SYSTEM AND METHOD

(71) Applicant: Zakareh Acton, Aubrey, TX (US)

(72) Inventor: Zakareh Acton, Aubrey, TX (US)

(21) Appl. No.: 16/031,056

(22) Filed: Jul. 10, 2018

Related U.S. Application Data
(60) Provisional application No. 62/530,625, filed on Jul. 10, 2017.

(51) Int. Cl. G06Q 30/00

(52) U.S. Cl. CPC G06Q 30/018

(57) ABSTRACT

An e-commerce system includes a processor; a database in communication with the processor; an e-commerce platform to be executed by the processor, the e-commerce platform having a business application module to receive data associated with a business applicant; a certification module to be executed by the processor, the certification module having a certification standard based on predetermined criteria; and the certification module is to evaluate the data associated with the business applicant to determine if the data qualifies the business applicant as meeting the certification standard; and the certification standard indicates that the business applicant has products that are 100% made in the United States.

### BACKGROUND

### 1. Field of the Invention

The present invention relates generally to commerce and e-commerce systems, and more specifically, to an e-commerce system and product analysis and certification system for certifying business as 100% made in the United States and providing a marker as indication of such certification.

### 2. Description of Related Art

Commerce systems are well known in the art and are effective means to provide products to customers for purchase. For example, FIG. 1 depicts a conventional commerce system 101 having a manufacturer 103 providing consumer products to a retailer 105 for purchase by a consumer 107.

As shown in FIG. 2, a flowchart 201 depicts a method associated with system 101. During use, the manufacturer purchases materials 109a-c from a plurality of countries and/or suppliers, as shown with box 203. The manufacturer can also use labor 111a-c associated with a plurality of countries during various steps in the manufacturing process, as shown with box 205. Finished products are eventually shipped to a retailer, wherein the retailer advertises the products for customers to purchase, as shown with boxes 207, 209, 211. It should be appreciated that during this process, the customer typically has little or no knowledge as to the origin of the components of the product.

One of the problems commonly associated with system 101 is lack of knowledge. For example, customers in the United States commonly wish to purchase products made within the U.S., however, it is difficult, if not impossible, for the customer to determine whether or not a product truly originated in the United States.

In addition, it should be understood that current systems adapted for determining and certifying whether a product is made in the United States fall short. The current standards merely require elements or parts of the final product to originate in the United States.

Accordingly, although great strides have been made in the area of commerce systems, many shortcomings remain.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is a simplified schematic of a common commerce system;

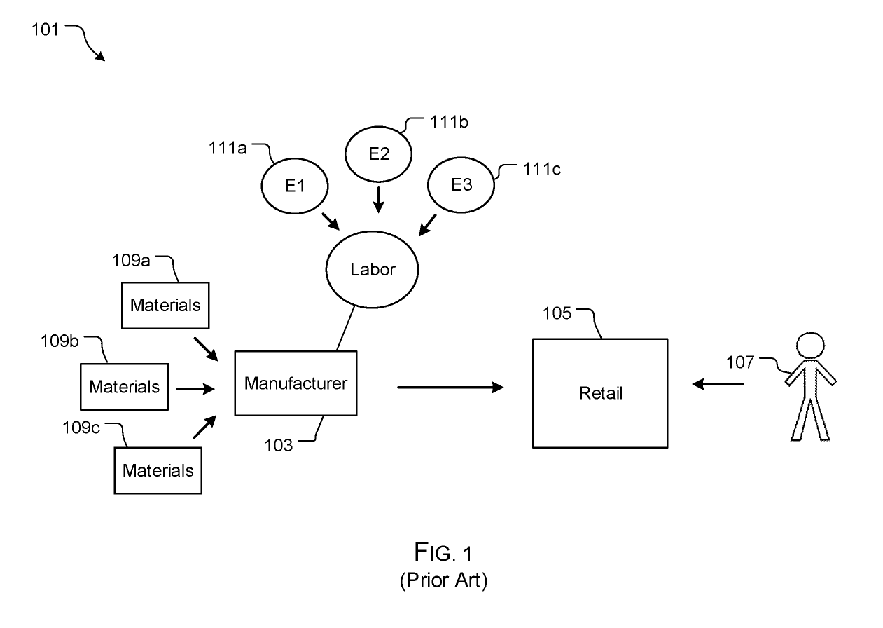

FIG. 2 is a flowchart of the method of FIG. 1;

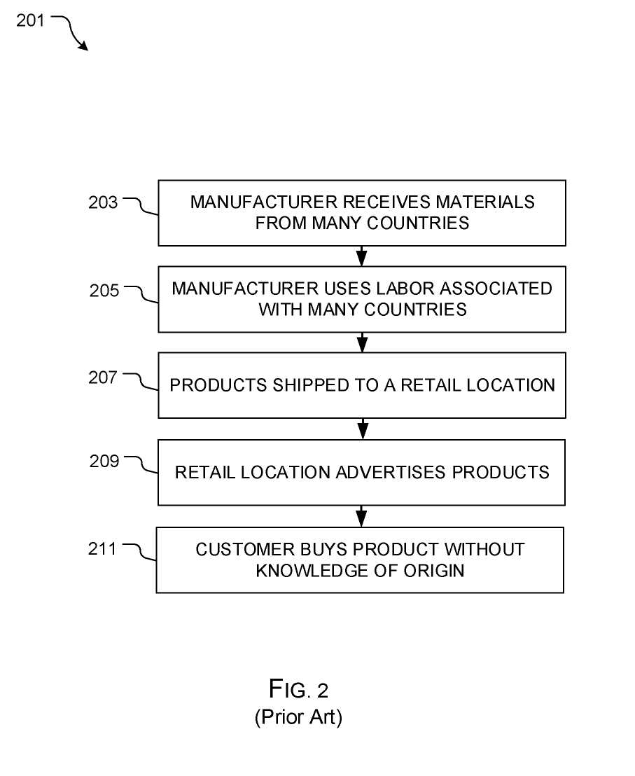

FIG. 3 is a simplified schematic of an e-commerce system in accordance with a preferred embodiment of the present application;

FIG. 4 is a simplified schematic of a business application module of FIG. 3;

FIG. 5 is a simplified schematic of a contracts associated with the system of FIG. 3; and

FIG. 6 is a flowchart of the method associated with FIG. 3.

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use in accordance with the present application overcomes one or more of the above-discussed problems commonly associated with conventional commerce systems. Specifically, the present invention provides a means to inform consumers as to the origin of products, namely when a product is 100% made in the United States. This and other unique features of the system and method of use are discussed below and illustrated in the accompanying drawings.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

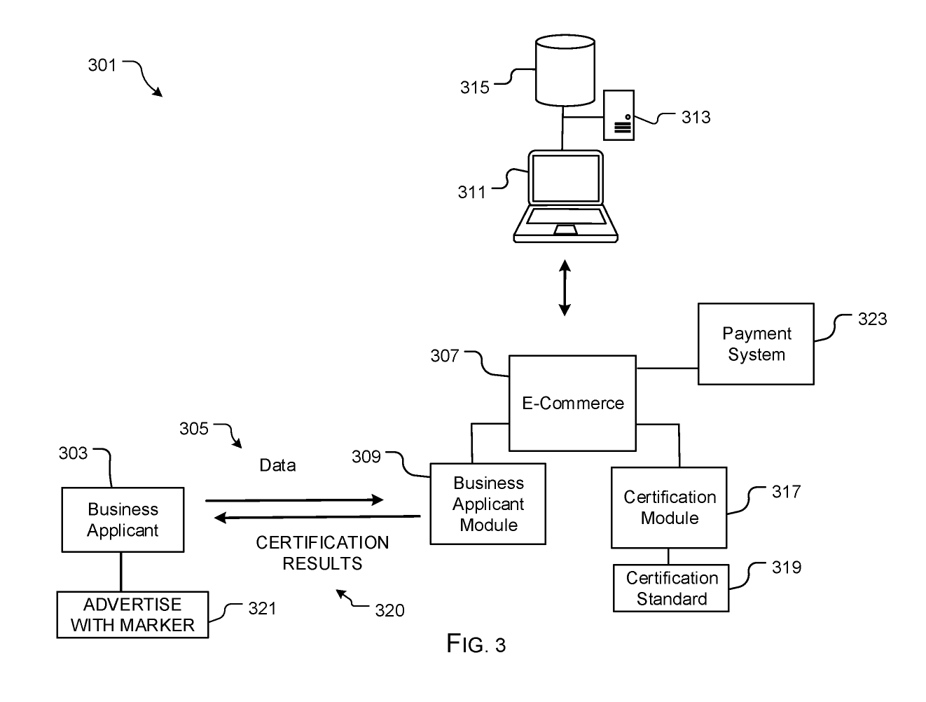

Referring now to the drawings wherein like reference characters identify corresponding or similar elements throughout the several views, FIG. 3 depicts a simplified schematic of an e-commerce system 301 in accordance with a preferred embodiment of the present application. It will be appreciated that system 301 overcomes one or more of the above-listed problems commonly associated with conventional commerce systems.

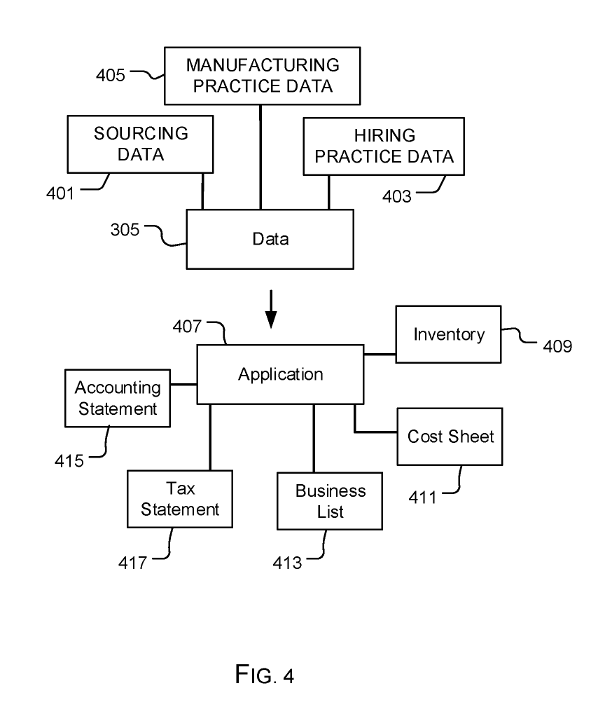

In the contemplated embodiment, system 301 includes a business applicant 303 providing data 305 associated with the business applicant's business practices into an e-commerce platform 307 via a business applicant portal 309. As shown in FIG. 4, data 305 associated with the business applicant can include manufacturing practices data 405, material sourcing data 401, and hiring practices data 403. In addition, the data is compiled into an application 407, wherein the application 407 can include one or more documents relating to the business practices of the applicant. The one or more documents can include an inventory list 409, a cost sheet 411 associated with inventory costs of the business, a list of all business 413 from which the business applicant purchases from, one or more accounting statements 415, and one or more tax statements 417. It should be appreciated that the documents required can be for a 1 year time frame, or for an extended time period.

Sourcing data 401 can include information such as the location where each material, including raw materials, chemicals, and other ingredients for the product, originate. In addition, sourcing data 401 can include information relating to obtaining the materials, such as companies and persons associated with obtaining and shipping the materials.

Hiring practice data 403 can include information relating to the citizenship of each employee and the working privileges of each employee within the United States.

Manufacturing practices data 405 can include data relating to locations of each step of manufacturing, any outsourcing involved in manufacturing, data associated with shipping of materials and products to and from the manufacturer, and any other relevant information.

System 301 further includes one or more of a computer 311 with a processor 313 and a database 315, wherein the computer and process are configured to execute functions associated with the various components of the e-commerce platform 307.

Platform 307 further includes a certification module 317 to be executed on the server and being associated with a certification standard 319. It should be appreciated that in the preferred embodiment, the certification standard 319 is related to products being made or services being offered by the business applicant as being 100% derived from USA based materials and labor.

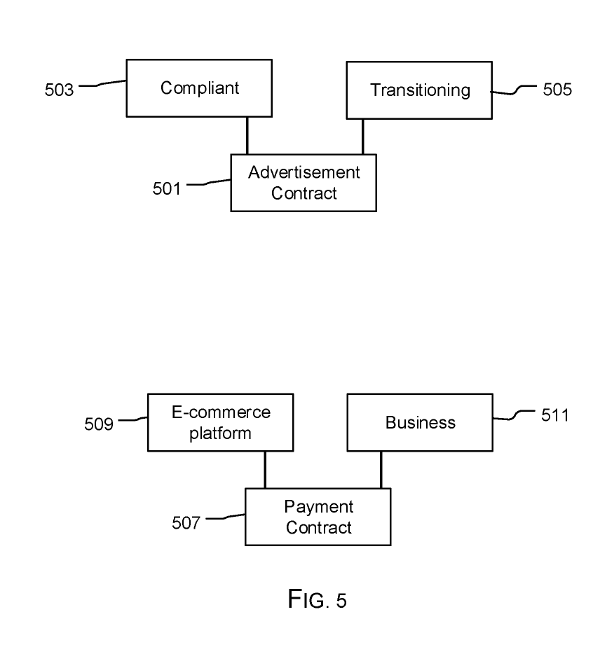

Based on certification results 320 as derived from data 305. The business applicant can enter into one or more contracts with a management system of e-commerce platform 307. As shown in FIG. 5, the business applicant can enter into an advertising contract 501, wherein the applicant receives permission to advertise with a certification mark 321 indicating the business applicant's compliance with the certification standard. In one embodiment, contract 501 includes a first option 503 indicating that the business applicant is 100% made in the USA compliant and a second option 505 indicating that the business applicant is in transition to becoming 100% made in America compliant and currently is at a specified percentage less than 100. It should be appreciated that the business can then function at a lower operating cost via contracting with the management system. The management system can compile the agreed prices for all networked businesses to access the e-commerce site for all of the business's needs.

It should be appreciated that contract 501 establishes how the business applicant can use the certification mark 321. In one embodiment, contract 501 lays out that the business is authorized to use the mark on invoices, business advertisements, uniforms, product packaging, products, and/or company vehicles. In addition, contract 501 will establish that the business applicant is authorized to place an advertisement relating to the compliance standard, indicating that the compliance standard represents 100% made in America products and labor. Because businesses operate in either manufacturing or service, or on different levels of chains, via city, state, or national, are of operation for their particular service, their niche will be determined by these factors.

As further shown in FIG. 5, a second contract 507 associated with a payment system 323 of e-commerce platform 307. Payment contract 507 will be used to determine money allocation between the e-commerce platform 509 and the business 511. It should be understood that money will be directed through platform 307 based on predetermined percentages.

In a preferred embodiment, 27% is allocated as a commission to the e-commerce system, with the remaining 73 percentage being broken down into Return on Investment Thirds. A first third is used to purchase collective collateral, such as tangible commodities associated with the business. The collective collateral is to be maintained and held by a management system of the e-commerce platform. Another third is to be returned to the business for investment, repairs, or as the business sees fit or to be donated to charity. The remaining third is funneled back into the business.

It should be appreciated that one of the unique features believed characteristic of the present application is e-commerce platform 307 having a business applicant module and a certification module, wherein one or more businesses complete applications to be evaluated to determine whether or not the internal workings of the business meet a certification standard. It should be appreciated that this feature, as well as other features of the invention provide means to ensure customers that they know where their products are coming from in every capacity. In addition, the present invention provides an improved means of advertising for businesses.

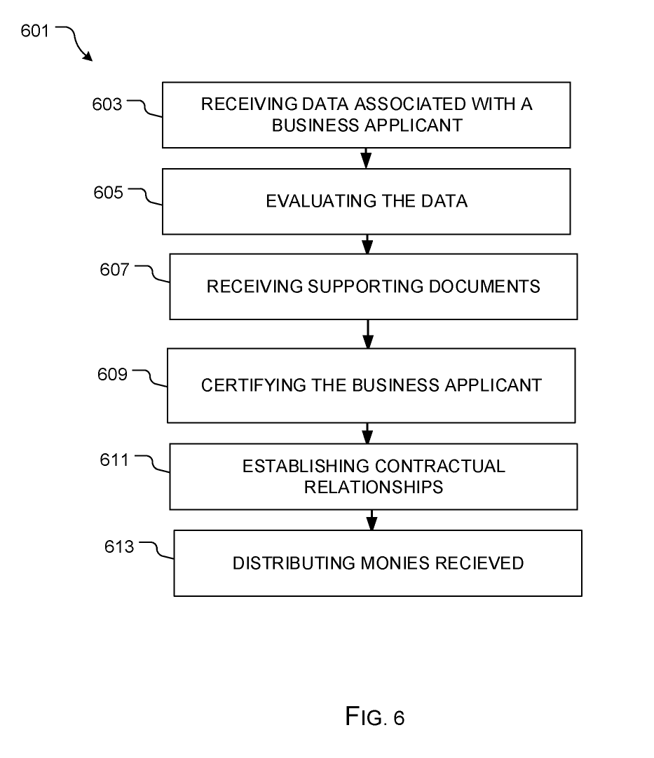

In FIG. 6, a flowchart 601 depicts a method of system 301. The e-commerce platform receives data relating to the business practices of a business applicant, as shown with box 603. The data, along with any supporting documents, are evaluated through the certification module, as shown with boxes 605, 607. If 100% of the data shows that the products and/or services of the business, along with all associated parts, components, and labor, originate in the United States, the business is certified, as shown with box 609. If the data does not meet the certification standard, then the product is denied certification, as shown with box 609. Contractual relationships are established affording the business applicant the right to advertise with a certification mark indicating that the business applicant has achieved certification or that the business applicant is transitioning toward certification, as shown with box 611. Lastly, monies earned by the business applicant are distributed according to additional contractual relationships.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed is:

1. An e-commerce system, comprising:
a processor;
a database in communication with the processor;
an e-commerce platform configured to be executed by the processor, the e-commerce platform having:
a business application module configured to receive data associated with a business applicant;
a certification module configured to be executed by the processor, the certification module having:
a certification standard based on predetermined criteria; and
wherein the certification module is configured to evaluate the data associated with the business applicant to determine if the data qualifies the business applicant as meeting the certification standard; and
wherein the certification standard indicates that the business applicant has products that are 100% made in the United States.

2. The system of claim 1, wherein the data has manufacturing practices data, material sourcing data, and hiring practices data.

3. The system of claim 1, wherein the business application module is configured to receive one or more documents.

4. The system of claim 3, wherein the one or more documents includes:
an inventory item list of all items needed to operate a business of the business applicant;
a cost sheet associated with inventory costs of the business;
a list of all businesses from which the business applicant purchases from;
one or more accounting statements for a specified time frame; and
one or more tax statements for the specified time period.

5. The system of claim 1, wherein the e-commerce platform further comprises:
a payment module configured to receive billing information from the business applicant.

6. The system of claim 1, further comprising:
a contract relating to certification of the business applicant as meeting the certification standard.

7. The system of claim 6, wherein the contract includes one or more options, the options having:
a first option indicating that the business applicant is 100% made in the USA compliant; and
a second option indicating that the business applicant is in transition to becoming 100% made in USA compliant and currently at a pre-established percentage.

8. The system of claim 6, wherein the contract includes an agreement allowing the business applicant to place a certification mark on a plurality of items associated with the business applicant.

9. The system of claim 8, wherein the plurality of items include one or more of invoices, business advertisements, uniforms, product packaging, and company vehicles.

10. The system of claim 1, further comprising:
a contract associated with monetary disbursement;
wherein a pre-defined percentage of money received by the business applicant is dispersed to a management system of the e-commerce platform; and
wherein a pre-defined percentage of money is retained by the business applicant.

11. The system of claim 1, wherein the certification standard requires that all material and labor associated with the product come from the United States.

12. A method of certifying a product, the method comprising:
providing the system of claim 1;
receiving the data associated with the business applicant through the business application module, the data having both tangible and intangible product information; and
evaluating the data through the certification module to determine if the data meets the certification standard.

13. The method of claim 12, further comprising:
certifying the product as 100% made in America based on the data meeting the certification standard;
wherein meeting the certification standard indicates that all materials, including raw materials and ingredients, and labor associated with the product originate from the United States only.

14. The method of claim 12, further comprising:
denying the product certification based on the data falling short of the certification standard.

15. The method of claim 12, further comprising:
receiving supporting documents relating to the data;
wherein the documents are used to determine accuracy of the data.

16. The method of claim 12, further comprising:
signing a contract between the business applicant and a management system of the e-commerce platform, wherein the business applicant receives permission to brand with a certification mark.

17. The method of claim 12, further comprising:
distributing monies received by the business applicant as determined by a contract setting percentages to be dispersed to a management system of the e-commerce platform and the business applicant.
